(19) United States
(12) Patent Application Publication
(10) Pub. No.: US 2016/0063555 A1
(43) Pub. Date: Mar. 3, 2016

(54) ADVERTISEMENT PLATFORM DEVICE AND OPERATING METHOD THEREOF

(71) Applicant: SK Planet Co., Ltd., Seongnam-si (KR)

(72) Inventor: Sang Mok SOHN, Seongnam-si (KR)

(21) Appl. No.: 14/836,763

(22) Filed: Aug. 26, 2015

(30) Foreign Application Priority Data
Aug. 26, 2014 (KR) 10-2014-0111648
Aug. 26, 2014 (KR) 10-2014-0111653
Sep. 4, 2014 (KR) 10-2014-0117975
Sep. 23, 2014 (KR) 10-2014-0126937

(51) Int. Cl. G06Q 30/02

(52) U.S. Cl. CPC G06Q 30/0257; G06Q 30/0252; G06Q 30/0271

(57) ABSTRACT

This specification discloses an advertisement platform device and an operating method thereof. That is, an advertisement effect can be greatly promoted by providing an advertisement, which is desired by a user, at time instants desired by the user for desired times by using advertisement subscription information registered from a terminal device.

### CROSS-REFERENCE TO RELATED APPLICATION

The instant application is based on and claims priority to Korean Patent Application No. 10-2014-0111648, filed on Aug. 26, 2014, Korean Patent Application No. 10-2014-0111653, filed on Aug. 26, 2014, Korean Patent Application No. 10-2014-0117975, filed on Sep. 4, 2014, and Korean Patent Application No. 10-2014-0126937, filed on Sep. 23, 2014. The disclosure of above-listed application is hereby incorporated by reference herein in their entirety.

### BACKGROUND OF THE INVENTION

1. Field of the Invention

The present invention relates to a measure of providing an advertisement, which is desired by a user, at time instants desired by the user for desired times by using advertisement subscription information registered from a terminal device.

Also, the present invention relates to providing a targeting advertisement by selecting a specific advertisement category, which is proper at the time instant when an advertisement request is received, among a plurality of advertisement categories which are selected by analyzing real time situation information related to a user.

Also, the present invention relates to a measure which, in selecting an advertisement registered by an advertiser as a targeting advertisement based on advertisement selection information, provides product information registered in a partner selling device instead of the advertisement, when the advertisement proper for the advertisement selection information does not exist.

Also, the present invention relates to a measure which provides the targeting advertisement by searching for a push advertisement target which is preselected by a push method even when a targeting logic of its own does not apply to an advertisement platform device which provides the targeting advertisement according to a pull method.

2. Description of the Related Art

As an application market, which is an advertisement medium executed on a mobile device such as a smart phone, a tablet, pad, etc. has proliferated rapidly, the advertisement market related to the advertisement medium is expanding at a high speed.

In this regard, when a mobile device (‘terminal device’, hereinafter) executes an application, which is the advertisement medium, or access a service page (web page), the terminal device receives the advertisement which is provided from an advertisement platform device and displays the advertisement.

In the meantime, the advertisement platform device establishes its own targeting logic for promoting the advertisement effect and selects the advertisement proper for characteristics of the user of the terminal device and provides the selected advertisement to the terminal device as the targeting advertisement.

However, even when the advertisement proper for the characteristics of the user of the terminal device is selected, a repulsive feeling can be generated when the advertisement is provided without the consent of the user, and then, the advertisement effect can be reduced due to the repulsion.

Therefore, a new measure for providing the advertisement, which is desired by a user, at a desired time instant for desired times is needed.

According to conventional targeting techniques, advertisements are classified into segments by their kinds, and it is determined that which advertisement belongs to which segment, such that the advertisement, which belongs to the determined segment can be provided as the targeting advertisement.

By the way, the segments which are adopted by the conventional targeting technique are limited in their kinds and numbers, and it is hard to amend and change the kinds and the numbers, and, therefore, it is difficult to provide high quality targeting advertisement, which reflects the time-varying current situation of the user, to the user.

Thus, a new measure which enables the high quality targeting advertisement which reflects the time-varying current situation of the user to be provided is needed.

Meanwhile, in order to improve performance of the advertisement platform device which provides advertisements according to the targeting technique as above, it is required that a large number of targeting subjects should be obtained, a high quality targeting logic for selecting the targeting advertisement has to be established, and a large number of advertisements to be provided to the terminal device, the targeting subject, should be guaranteed.

By the way, when there are not enough advertisements prepared in the advertisement platform device, the targeting advertisement cannot be provided at right times, which degrades an advertisement conversion rate and results in performance degradation of the advertisement platform device.

As a result, a new measure, which can prevent the performance degradation of the advertisement platform device due to an insufficient amount of advertisements prepared in the advertisement platform device, is needed.

Meanwhile, the terminal device receives the targeting advertisements according to a first advertisement provision method (′push method, hereinafter) and a second advertisement provision method (′pull method, hereinafter) at the same time, and, therefore, the advertisement platform device which provides the advertisement according to the push method can exist separately from the advertisement platform device which individually provides the advertisement according to the pull method.

By the way, the respective advertisement platform devices should have separate targeting logics for providing the targeting advertisements to the terminal device on their own, which is very cumbersome.

Therefore, a new measure which integrates the targeting logics according to the push method and the pull method with each other is needed.

### SUMMARY OF THE INVENTION

The present invention has been made by considering these affairs, and the object of the present invention is to promote the advertisement effect greatly by providing an advertisement, which is desired by a user, at time instants desired by the user for desired times by using advertisement subscription information registered from a terminal device.

Also, another object that is to be come by according to the present invention is to reduce a system load and improve accuracy in selecting a targeting advertisement by selecting a specific advertisement category, which is proper at the time instant when an advertisement request is received, among a plurality of advertisement categories which are selected by analyzing real time situation information related to a user, and providing the selected advertisement as the targeting advertisement.

Also, another object that is to be come by according to the present invention is to improve an advertisement conversion rate, in selecting an advertisement registered by an advertiser as a targeting advertisement based on advertisement selection information, by providing product information registered in a partner selling device as the targeting advertisement, when the advertisement proper for the advertisement selection information does not exist.

Also, another object that is to be come by according to the present invention is to enable the targeting advertisement to be provided, even when separate targeting logic is not employed, by providing the product selection information does not exist by searching for a push advertisement target which is selected according to a push method in the advertisement platform device which provides the targeting advertisement according to a pull method.

The advertisement platform device to achieve the above objects according to one aspect of the present invention is characterized in comprising: a determining unit which, when an advertisement request is received from a terminal device, determines whether an advertisement provision toward the terminal device is possible based on the advertisement subscription information for restricting a reception of the advertisement at the terminal device; and a control unit which, when it is determined that the advertisement provision toward the terminal device is possible, enables an advertisement which is selected for the terminal device to be provided to the terminal device.

The advertisement platform device to achieve the above objects according to one aspect of the present invention is characterized in comprising: a providing unit which provides advertisements to a terminal device according to a first advertisement provision method; an acknowledging unit which, when identification information is received from the terminal device, acknowledges whether the identification information has been generated for the terminal device at another advertisement platform device which conforms to a second advertisement provision method; and a control unit which, when the identification information is acknowledged to have been generated for the terminal device, enables a specific advertisement, which is selected to be provided from the another advertisement platform device to the terminal device, to be provided according to the first advertisement provision method.

A method of operating the advertisement platform device to achieve the above objects according to one aspect of the present invention is characterized in comprising: a determining step which, when an advertisement request is received from a terminal device, determines whether an advertisement provision toward the terminal device is possible based on the advertisement subscription information for restricting a reception of the advertisement at the terminal device; and a control step which, when it is determined that the advertisement provision toward the terminal device is possible, enables an advertisement which is selected for the terminal device to be provided to the terminal device.

By adopting the advertisement platform device and the method of operating the advertisement platform device according to the present invention, the advertisement effect can be greatly promoted by providing an advertisement, which is desired by a user, at time instants desired by the user for desired times by using advertisement subscription information registered from a terminal device.

Also, by adopting the advertisement platform device and the method of operating the advertisement platform device according to the present invention, it is possible to reduce a system load and improve accuracy in selecting a targeting advertisement by selecting a specific advertisement category, which is proper at the time instant when an advertisement request is received, among a plurality of advertisement categories which are selected by analyzing real time situation information related to a user, and providing the selected advertisement as the targeting advertisement.

Also, by adopting the advertisement platform device and the method of operating the advertisement platform device according to the present invention, an advertisement conversion rate can be greatly improved in selecting an advertisement registered by an advertiser as a targeting advertisement based on advertisement selection information by providing product information registered in a partner selling device as the targeting advertisement, when the advertisement proper for the advertisement selection information does not exist.

### BRIEF DESCRIPTION OF THE DRAWINGS

FIG. 1 is a schematical configuration of an advertisement providing system according to a first embodiment of the present invention.

FIG. 2 is a schematical configuration of an advertisement platform device according to the first embodiment of the present invention.

FIG. 3 is a diagram for illustrating a registration process of advertisement subscription information according to the first embodiment of the present invention.

FIG. 4 is a schematical flowchart for illustrating operation flows of the advertisement platform device according to the first embodiment of the present invention.

FIG. 5 is a schematical configuration of an advertisement providing system according to a second embodiment of the present invention.

FIG. 6 is a schematical configuration of an advertisement platform device according to the second embodiment of the present invention.

FIG. 7 is a schematical flowchart for illustrating operation flows of the advertisement platform device according to the second embodiment of the present invention.

FIG. 8 is a schematical configuration of an advertisement providing system according to a third embodiment of the present invention.

FIG. 9 is a schematical configuration of an advertisement platform device according to the third embodiment of the present invention.

FIG. 10 is a schematical flowchart for illustrating operation flows of the advertisement platform device according to the third embodiment of the present invention.

FIG. 11 is a schematical configuration of an advertisement providing system according to a fourth embodiment of the present invention.

FIG. 12 is a schematical configuration of a pull advertisement platform device according to the fourth embodiment of the present invention.

FIG. 13 is a schematical flowchart for illustrating operation flows of the pull advertisement platform device according to the fourth embodiment of the present invention.

### DETAILED DESCRIPTION OF THE INVENTION

Technical terms used herein are used merely for illustrating specific embodiments, and it is to be noted that they are not intended to limit technical spirit disclosed in this specification. Also, the technical terms used herein are to be construed by the meanings normally accepted by the person having ordinary skill in the relevant art, unless specifically defined by other meanings in this specification, and it is neither to be construed by excessively comprehensive meanings nor excessively narrow meanings. Also, when the technical terms used herein are determined to be wrong technical terms which fail to represent the technical spirit disclosed in this specification correctly, the terms are to be replaced by the technical terms which can be accurately understood by the person having ordinary skill in the art. Also, the general terms used in this specification are to be construed as defined in the dictionaries or according to context, and they are not to be construed in an excessively narrow meaning.

Also, the singular representation used in this specification includes plural representations unless it is clearly expressed in the context to the contrary. The terms “include” or “is composed of” in this specification are not to be construed to necessarily include all components and all steps cited in this specification, and it should be construed to exclude some components or some steps or further include additional components and steps.

Also, the terms representing an ordinal number such as first, second, etc. used in this specification can be used to explain various components, however, the components are not to be limited by these terms. These terms are used only for discriminate one component from other components. For example, the first component can be entitled as a second component, and similarly, the second component can be entitled as the first component, without departing from the technical scope of the present invention.

In the following, embodiments disclosed in this specification are to be described in detail by referring to the appended figures, wherein the same reference numerals are given to the same or like components irrespective of the number of the figures, and duplicate description on them will be omitted.

Also, when it is determined that a detailed description on a relevant known art will obscure the subject matter disclosed in the specification while describing the technologies disclosed in this specification, the detailed description will be omitted. Also, it is to be noted that the appended figures are only for facilitating the technical spirit disclosed in this specification and the technical spirit are not to be construed to be limited by the appended figures.

Hereinafter, a first embodiment of the present invention is described by referring to appended drawings.

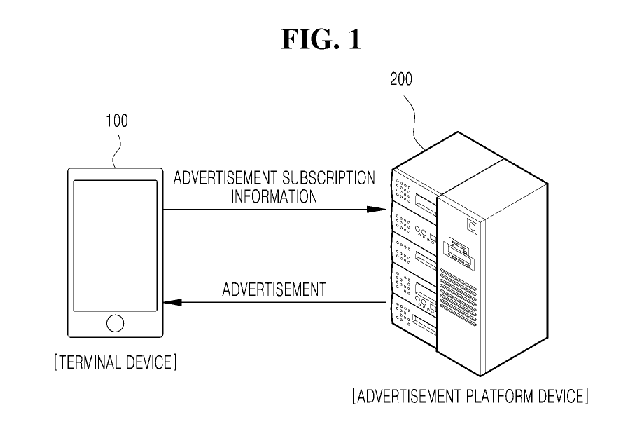

FIG. 1 is diagram showing an advertisement providing system according to a first embodiment of the present invention.

As shown in FIG. 1, the advertisement providing system according to the first embodiment of the present invention has a configuration comprising: a terminal device 100 which receives an advertisement, and an advertisement platform device 200 which provides the advertisement to the terminal device 100.

The terminal device 100 refers to a mobile device which can receive the advertisement through an advertisement medium.

For example, a smart phone, a tablet PC, a PDA, and etc. can be included in the terminal device 100, and the terminal device 100 is not limited to these, and can include all devices which can receive the advertisement.

Here, the advertisement medium which enables the reception of the advertisement on the terminal device 100 can include, for example, an application which is executed on the terminal device 100 itself, or a service page (e.g.: web page) which the terminal device 100 can access through a called browser.

The advertisement platform device 200 refers to an advertisement server which provides the advertisement to the terminal device 100.

When an advertisement is requested from the terminal device 100, this advertisement platform device 200 can guarantee the advertisement effect by adopting a method of selecting an advertisement which has a high probability to be clicked on the terminal device 100, and providing the selected advertisement to the terminal device 100.

Meanwhile, according to an embodiment of the present invention, when an advertisement request is received from the terminal device 100, the advertisement platform device 200 selects the advertisement which is proper for the user who carries the terminal device 100 and provides the selected advertisement to the terminal device 100.

Generally, a targeting technique refers to a method of selecting an advertisement proper for the characteristics of a user who carries the terminal device 100 and providing the selected advertisement to the terminal device 100.

This targeting technique can somewhat improve an advertisement effect to a certain degree by providing the advertisement proper for the characteristics of the user, however, the advertisement effect cannot be guaranteed when an approval for reception of the corresponding advertisement is not guaranteed.

That is, even when the advertisement proper for the characteristics of the user is selected, a repulsive feeling can be generated when the advertisement is provided without the consent of the user, and then, the advertisement effect can be reduced due to the repulsion.

Therefore, differently from the conventional targeting technique, one embodiment of the present invention tries to provide a measure for providing the advertisement desired by the user at a time instant desired by the user, and the configuration of the advertisement platform device 200 for accomplishing this will be explained in detail in the following.

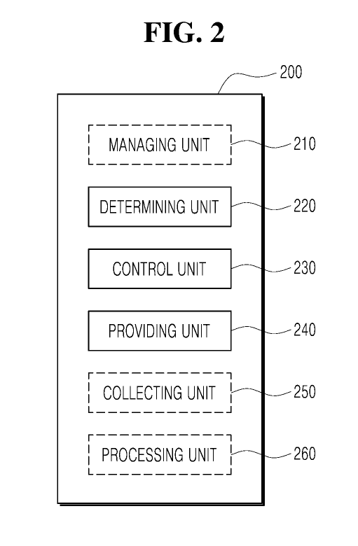

FIG. 2 is a diagram showing a schematic configuration of an advertisement platform device 200 according to the first embodiment of the present invention.

As shown in FIG. 2, the advertisement platform device 200 according to the first embodiment of the present invention has a configuration comprising: a determining unit 220 which determines whether the advertisement can be provided to the terminal device 100, and a control unit 230 which provides the selected advertisement to the terminal device 100.

Also, the advertisement platform device 200 according to the first embodiment of the present invention can have a configuration which further comprises, in addition to the aforementioned configuration, a managing unit 210 which stores and manages the advertisement subscription information which is registered from the terminal device 100, a providing unit 240 which provides the advertisement to the terminal device 100, a collecting unit 250 which collects event information related to the advertisement, and a processing unit 260 which processes a reward for the terminal device 100.

Here, all or a part of the configuration of the advertisement platform device 200 comprising the aforementioned managing unit 210, the determining unit 220, the control unit 230, the providing unit 240, the collecting unit 250, and the processing unit 260 can be implemented as a software module executed by a processor or as a combination of the software module and a hardware.

At first, the managing unit 210 performs a function of managing the advertisement subscription information.

More specifically, the advertisement platform device 200 stores the advertisement subscription information when the advertisement subscription information registered by the terminal device 100 is received, and enables a selective advertisement provision to the terminal device 100 by acknowledging the stored advertisement subscription information when the advertisement request is received from the terminal device 100.

In connection with this, the terminal device 100 registers the advertisement subscription information for receiving the advertisement from the advertisement platform device 200, and transmits the registered advertisement subscription information to the advertisement platform device 200, such that the advertisement can be stored and managed.

Here, the advertisement subscription information refers to the information which is registered for receiving the advertisement desired by the user at a time instant desired by the user, and it can include, for example, an advertisement reception permission number which is the number of receptions for the advertisement for a specific advertisement reception period (e.g.: one day) set by the user, and the advertisement category which the user wishes to receive.

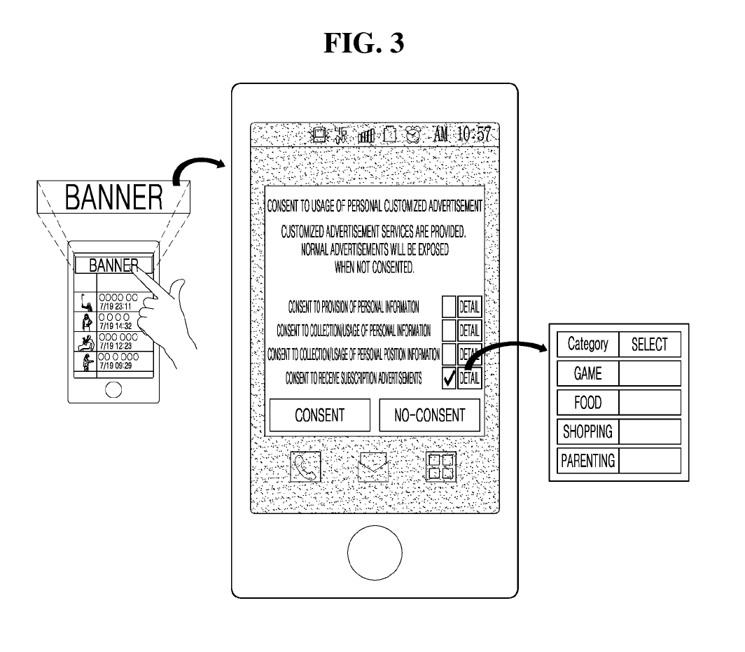

The registration process for the advertisement subscription information can be performed as shown in FIG. 3.

That is, when an application, which acts as the advertisement medium, is executed by the terminal device 100, a banner related to the registration of the advertisement subscription information can be displayed, and, when the user selects the banner, a guidance for subscribing to the advertisement reception service (e.g.: subscription advertisement) using the advertisement subscription information can be provided.

In the meantime, when the user approves to subscribe to the subscription advertisement service, substantial registration of the advertisement subscription information is performed, the registration process of this advertisement subscription information can be performed by setting the advertisement reception period and the advertisement reception permission numbers for each advertisement reception period while selecting the advertisement category (e.g.: game, food, shopping, parenting) that the user wishes to receive.

The determining unit 220 performs a function of determining whether an advertisement provision to the terminal device 100 is possible.

More specifically, when the advertisement request is received from the terminal device 100, the determining unit 220 determines whether the advertisement can be provided to the terminal device 100 which requested the advertisement.

Here, the determining unit 220 determines whether the advertisement provision for the terminal device 100 is possible at the time instant when the advertisement request is received from the terminal device 100, by extracting and acknowledging the registered advertisement subscription information from the terminal device 100.

In connection with this, the determining unit 220 comes to acknowledge the advertisement reception period, which is set by the terminal device 100, and the advertisement reception permission numbers for the respective advertisement reception periods from the advertisement subscription information.

In the meantime, when there is advertisement reception permission number left for the advertisement reception period to which the time instant when the advertisement request is received from the terminal device 100 belongs, the determining unit 220 determines that the advertisement can be provided to the terminal device 100.

For example, it can be assumed that the advertisement reception period is a ‘6 hour’ unit, and the advertisement reception permission number is set to be ‘three times’ for the respective advertisement reception periods.

In the meantime, if the advertisement has been already provided to the terminal device 100 two times before the advertisement request is received from the terminal device 100, it can be determined that the advertisement can be provided to the terminal device 100 since there still remains one time left for the advertisement reception permission number.

On the contrary, if the advertisement has been already provided to the terminal device 100 for three times, that is for the advertisement reception permission number, at the time instant when the advertisement request is received from the terminal device 100, it can be determined that the advertisement cannot be provided to the terminal device 100.

In this case, it can be determined that the advertisement provision is possible for the terminal device 100 only when a new advertisement request is received from the terminal device 100 after the next advertisement reception period begins.

Meanwhile, as for the advertisement subscription information, it can be stored not only on the advertisement platform device 200 but also on the terminal device 100 which actually performs the registration process.

Like this, when the advertisement subscription information is stored again for the terminal device terminal device 100, the terminal device 100 also can estimate how much times the advertisement has been received for the current advertisement reception period at the time instant when the advertisement request is delivered.

As a result, the advertisement request can be delivered to the advertisement platform device 200 only when there still exists the advertisement reception permission number left for the current advertisement reception period of the terminal device 100 itself, and, in this case, the operation of acknowledging the advertisement permission number performed in the determining unit 220 can be omitted.

Also, in order to acknowledge whether the advertisement provision for the terminal device 100 is possible, the determining unit 220 additionally acknowledge the advertisement category included in the advertisement subscription information.

That is, the determining unit 220 acknowledges the advertisement category which is selected by the terminal device 100 from the advertisement subscription information, and further acknowledges whether there exist new advertisements which are not received by the terminal device 100 during the current advertisement reception period among the advertisements which belong to the selected advertisement category.

In the meantime, the determining unit 220 determines that the advertisement provision for the terminal device 100 is possible, when it is acknowledged that there exists the new advertisement which belongs to the advertisement category selected by the terminal device 100 and which is not received by the terminal device 100 during the current advertisement reception period.

Meanwhile, although the description is based on the situation that the advertisement which is not received by the terminal device 100 is acknowledged during the current advertisement reception period, this can be set to be expanded to an operation of acknowledging the advertisement which is not received by the terminal device 100 for a plurality of advertisement reception periods.

For reference, when there is no new advertisement which is not received by the terminal device 100 during the current advertisement reception period, a measure, which does not provide the advertisement at all or provides the advertisement in a similar advertisement category, is also possible.

The control unit 230 performs an advertisement selecting function.

More specifically, when it is determined that the advertisement can be provided to the terminal device 100, the control unit 230 selects an advertisement proper for the terminal device 100, and enables the providing unit 240 to provide the selected advertisement to the terminal device 100.

In the meantime, the control unit 230 acknowledges the advertisement category which is selected by the terminal device 100 from the advertisement subscription information, and selects one of the advertisements which are yet to be provided to the terminal device 100 during the current advertisement reception period to which the time instant, when the advertisement request is received from the 100, belongs, among the advertisements pertaining to the acknowledged advertisement category, as the advertisement which is to be provided to the terminal device 100.

The collecting unit 250 performs an event information collecting function.

More specifically, when an event (e.g.: clicks) related to the advertisement occurs in the terminal device 100 after the selected advertisement is provided to the terminal device 100, the collecting unit 250 collects and cumulatively stores the corresponding event information, thereby enabling the processing unit 260 to provide the predefined reward (e.g.: coupons, discount coupons, and points) to the terminal device 100 according to the accumulation value of the event information.

In connection with this, when the advertisement type of the advertisement provided from the advertisement platform device 200 is a CPM (Cost Per Mile, Cost Per thousand iMpression, Cost Per Millennium) advertisement, the terminal device 100 can notify that the advertisement which is received from the advertisement platform device 200 is normally displayed to the advertisement platform device 200 by using the event information.

Meanwhile, when the advertisement type of the advertisement provided from the advertisement platform device 200 is a CPC (Cost Per Click) advertisement, it can be notified to the advertisement platform device 200 that a selection event (click) of the user occurs in connection with the advertisement which is received from the advertisement platform device 200 and displayed, such that it can be collected as the event information.

As described in the above, according to the advertisement platform device according to the first embodiment of the present invention, the advertisement related to the advertisement category which is selected by the user can be provided at a desired time instant by using the advertisement subscription information registered from the terminal device 100, thereby improving a response rate about the advertisement and improving competitiveness of the advertisement service with a high click to rate (CTR), and, furthermore, the advertisement can be greatly improved by providing rewards in relation to the reception of the advertisement.

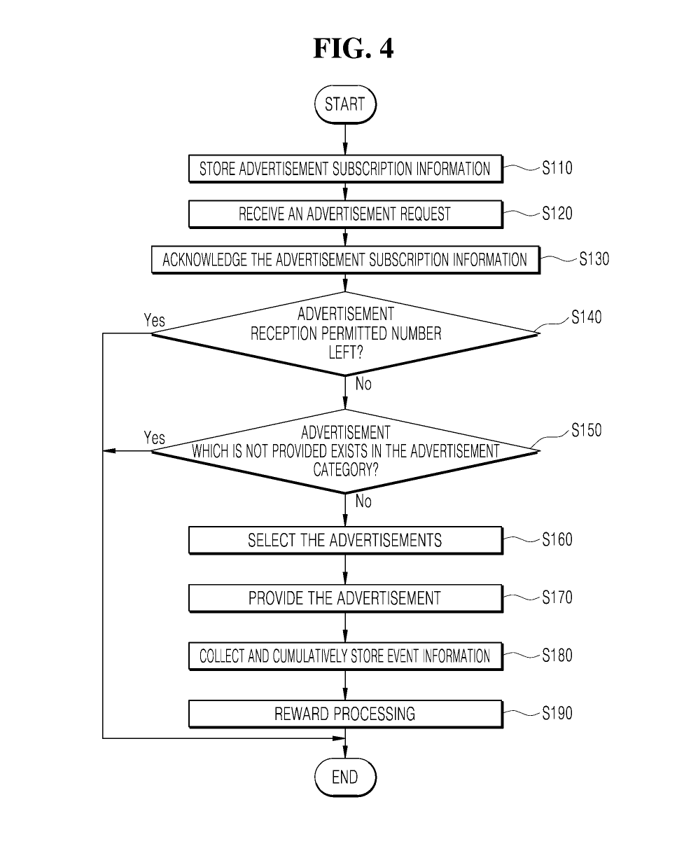

In the following, operations flows of the advertisement platform device according to the first embodiment of the present invention are explained by referring to FIG. 4.

Here, the configurations described in the FIGS. 1 to 3 are referred to by using corresponding reference numbers for the convenience of description.

At first, the advertisement platform device 200 stores the advertisement subscription information when the advertisement subscription information registered by the terminal device 100 is received, and adopts a technique to acknowledge the advertisement subscription information which is registered from the terminal device 100 among the stored advertisement subscription information, when the advertisement request is received from the terminal device 100, thereby realizing selective advertisement provision (S110).

Then, when the advertisement request is received from the terminal device 100, the determining unit 220 determines whether the advertisement provision for the terminal device 100 is possible at the time instant when the advertisement request is received from the terminal device 100, by extracting and acknowledging the registered advertisement subscription information from the terminal device 100 among the stored advertisement subscription information (S120-S140).

In the meantime, when there is advertisement reception permission number left for the advertisement reception period to which the time instant when the advertisement request is received from the terminal device 100 belongs, the determining unit 220 comes to determine that the advertisement can be provided to the terminal device 100.

For example, it can be assumed that the advertisement reception period is a ‘6 hour’ unit, and the advertisement reception permission number is set to be ‘three times’ for the respective advertisement reception periods.

Here, if the advertisement has been already provided to the terminal device 100 two times before the advertisement request is received from the terminal device 100, it can be determined that the advertisement can be provided to the terminal device 100 since there still remains one time left for the advertisement reception permission number.

In addition, the determining unit 220 comes to acknowledge the advertisement category which is selected by the terminal device 100 from the advertisement subscription information, and further acknowledges whether there exist new advertisements which are not received by the terminal device 100 during the current advertisement reception period among the advertisements which belong to the selected advertisement category.

In the meantime, the determining unit 220 determines that the advertisement provision for the terminal device 100 is possible, when it is acknowledged that there exists the new advertisement which belongs to the advertisement category selected by the terminal device 100 and which is not received by the terminal device 100 during the current advertisement reception period.

Meanwhile, although the description is based on the situation that the advertisement which is not received by the terminal device 100 is acknowledged during the current advertisement reception period, this can be set to be expanded to an operation of acknowledging the advertisement which is not received by the terminal device 100 for a plurality of advertisement reception periods.

Furthermore, when it is determined that the advertisement can be provided to the terminal device 100, the control unit 230 selects an advertisement proper for the terminal device 100, and enables the providing unit 240 to provide the selected advertisement to the terminal device 100 (S160-S170).

In the meantime, the control unit 230 acknowledges the advertisement category which is selected by the terminal device 100 from the advertisement subscription information, and selects one of the advertisements which are yet to be provided to the terminal device 100 during the current advertisement reception period to which the time instant, when the advertisement request is received from the 100, belongs, among the advertisements pertaining to the acknowledged advertisement category, as the advertisement which is to be provided to the terminal device 100.

Then, when an event (e.g.: clicks) related to the advertisement occurs in the terminal device 100 after the selected advertisement is provided to the terminal device 100, the collecting unit 250 collects and cumulatively stores the corresponding event information, thereby enabling the processing unit 260 to provide the predefined reward (e.g.: coupons, discount coupons, and points) to the terminal device 100 according to the accumulation value of the event information (S180-S190).

As described in the above, according to the operation flow of the advertisement platform device 200 according to the first embodiment of the present invention, the advertisement related to the advertisement category which is selected by the user can be provided at a desired time instant by using the advertisement subscription information registered from the terminal device 100, thereby improving a response rate about the advertisement and improving competitiveness of the advertisement service with a high click to rate (CTR), and, furthermore, the advertisement can be greatly improved by providing rewards in relation to the reception of the advertisement.

Hereinafter, the second embodiment of the present invention will be described in detail by referring to appended drawings.

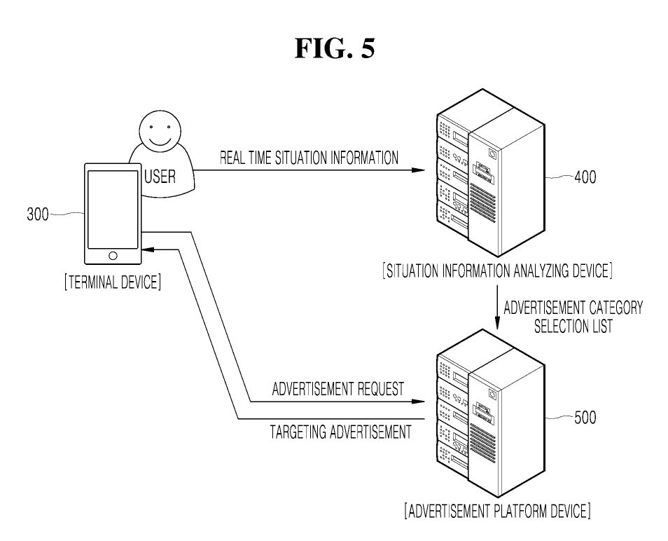

FIG. 5 is diagram showing an advertisement providing system according to the second embodiment of the present invention.

As shown in FIG. 5, the advertisement providing system according to the second embodiment of the present invention has a configuration including a terminal device 300 which receives advertisements through an advertisement medium, a situation analyzing device 400 which analyzes real-time situations for a user who carries the terminal device 300, and an advertisement platform device 500 which provides the targeting advertisement to the terminal device 300.

The terminal device 300 refers to a mobile device which can receive the advertisement through an advertisement medium.

For example, a smart phone, a tablet PC, a PDA, and etc. can be included in the terminal device 300, and the terminal device 100 is not limited to these, and can include all devices which can receive the advertisement.

Here, the advertisement medium which enables the reception of the advertisement on the terminal device 100 can include, for example, an application which is executed on the terminal device 100 itself, or a service page (e.g.: web page) which the terminal device 100 can access through a called browser.

This advertisement medium includes a software development kit (SDK) which is related to the advertisement reception during a development process, and, the, the terminal device 300 performs a series operation of requesting, receiving, and displaying the advertisement through the SDK included in the advertisement medium.

The situation information analyzing device 400 refers to a server which collects real-time situation information occurring in relation to the current state of the user who carries the terminal device 300 and analyzes the information.

Here, the real-time situation information is related to the current state of the user who carries the terminal device 300 as mentioned above and can include, for example, a browsing (selection) history for the advertisement performed on the terminal device 300, purchase information, reservation information, and position information etc., and is not limited to these but can include all information which can be used to acknowledge the current state.

The advertisement platform device 500 refers to a platform server which provides the advertisement which is registered from the advertiser to the terminal device 300.

When an advertisement provision is requested from the terminal device 300, this advertisement platform device 500 determines the targeting advertisement which is proper for the terminal device 300 among the advertisements which are registered from the advertiser, and provides the targeting advertisement to the terminal device 300.

Meanwhile, according to the second embodiment of the present invention, when the advertisement request is received from the terminal device 300, the advertisement platform device 500 adopts a targeting technique which identifies the user who carries the data driving unit 30 by using the identification information (e.g.: MDN, IMEI etc.), determines the targeting advertisement proper for the identified user, and provides the determined targeting advertisement to the terminal device 300.

According to the conventional targeting technique, types of advertisement (e.g.: travel, sports, housing, clothing, restaurants, games, etc.) are classified into segments, the segment to which the user pertains is determined, and the advertisement which belongs to the determined segment is provided as the targeting advertisement.

By the way, as for the segments mentioned above, it is actually difficult to amend and change the segments, and the types of the advertisement which are classified by the segments are limited and have standardized forms, which makes it difficult to determine the targeting advertisement which best reflect the current situation of the user that can vary in real time.

For example, according to the conventional targeting technique, when it is assumed that the user has made a hotel reservation as the current situation, the type of the advertisements, which are classified based on the segments, is ‘hotel-related’, and an advertisement having a ‘frequent traveler’ with a targeting condition at the time of registering the advertisement by the advertiser can be provided to the corresponding user.

By the way, when the time instant when the hotel reservation was made is far apart from the time instant when the targeting advertisement is provided, the current situation of the user is quite different from the past of the user who actually made the hotel reservation, and the effectiveness of the corresponding targeting advertisement comes to be greatly reduced.

As a result, it can be appreciated that a new targeting technique which can reflect the time-varying current situation of the user, rather than the conventional method which selects the advertisement classified based on segments, is required in order to improve accuracy of the targeting advertisement.

Therefore, according to the second embodiment of the present invention, a targeting measure which can reflect the current situation of the user who carries the terminal device 300 is proposed, and the configuration of the advertisement platform device 500 for implementing the new method will be explained in detail in the following.

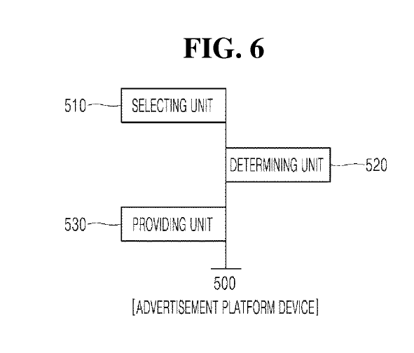

FIG. 6 is a diagram schematically showing the configuration of an advertisement platform device 500 according to the second embodiment of the present invention.

As shown in FIG. 6, the advertisement platform device 500 according to the second embodiment of the present invention can have a configuration including a selecting unit 510 which selects the advertisement category that is proper for the user carrying the terminal device 300, and a determining unit 520 which determines the targeting advertisement.

Also, the advertisement platform device 500 according to the second embodiment of the present invention can have a configuration which further includes a providing unit 530 that provides the determined targeting advertisement to the terminal device 300, in addition to the aforementioned configuration.

Here, all or a part of the configuration of the advertisement platform device 500 comprising the aforementioned selecting unit 510, the determining unit 520, and the providing unit 530 can be implemented as a software module executed by a processor or as a combination of the software module and a hardware.

The collecting unit 510 performs a function of selecting an advertisement category.

More specifically, when the advertisement request is received from the terminal device 300, the selecting unit 510 receives a plurality of advertisement category lists which are preselected by the situation analyzing device 400, and selects the advertisement category which is best proper for the current situation of the user who carries the terminal device 300 among the received advertisement category lists.

In the meantime, the selecting unit 510 selects the advertisement category based on the time instant when the advertisement request is received from the terminal device 300.

That is, selecting unit 510 first selects the advertisement categories for which the selection permitted time has not elapsed at the time instant when the advertisement request is received from the terminal device 300 among the advertisement categories selected by the situation analyzing device 400, and then selects a specific advertisement category with the highest priority as the advertisement category which is most proper for the current situation of the user among the selected advertisement categories.

In connection with this, the situation information analyzing device 400 collects the real-time situation information occurring in relation to the current situation of the user who carries the terminal device 300, and analyzes the collected real-time situation information to select a plurality of advertisement categories whose effectiveness is high for the user.

For example, when it is assumed that the user who carries the terminal device 300 has have his/her round-trip airplane ticket ticketed, and departure time, departure and arrival times printed on the airplane ticket, position information, etc. are collected as the real-time situation information, the situation analyzing device 400 can infer the real time situation of the user by analyzing the collected real-time situation information.

In this case, the situation information analyzing device 400 can select a theme of ‘travel’ as a major classification, and then select a plurality of advertisement categories ((e.g.: duty-free shops, housing, travel guidance, etc.) included in the theme of travel as minor classifications which have high effectiveness for the user.

In the meantime, priorities can be assigned to the selected advertisement categories according to predefined urgency at the time instant when the real-time situation information is received, and the situation information analyzing device 400 assigns priorities to each of the selected advertisement categories according to the order of urgency at the time instant when the real-time situation information is collected.

Here, urgency refers to a time sequence until the time instant when the current situation of the user changes and the effectiveness of the selected advertisement category wears out.

For example, in case that the current time instant is close to an airplane boarding time of the user, the situation information analyzing device 400 can infer that the current situation of the user is ‘waiting for a boarding’ of the plane.

In the meantime, the situation information analyzing device 400 can acknowledge the advertisement category whose effectiveness first wears out after the boarding time of the plane (e.g.: duty-free shops) as the category with the highest urgency among the advertisement categories which are selected in relation to ‘travel’.

As mentioned above, each of the selected categories has its effectiveness which wears out as the current situation of the user varies, and as a measure for representing the effectiveness of each of the selected categories, the situation analyzing device 400 sets a selection permitted time having a continuous time flow according to the assigned priority from the time instant when the real time situation information was collected for each of the selected advertisement categories.

As for the aforementioned examples, when it is inferred that the user is planning a travel from the collected real-time situation information, the situation information analyzing device 400 sets a time period from the time instant when the real-time situation information was collected to the time instant when the travel ends as an overall period, divides the overall period for the respective selected advertisement categories according to the priorities, and sets the divided result as the selection permitted time for each of the advertisement categories.

As a result, it can be meant that during each of the advertisement categories, the effectiveness of the advertisement categories can be maintained for the user from the time instant when the real-time situation information is collected to the time instant when the selection permitted time which is set for the user expires.

For reference, the priorities for the advertisement categories which are selected by the situation analyzing device 400 and the related information can be included in the selected advertisement categories as tag information, respectively.

The determining unit 520 performs a function of determining a targeting advertisement.

More specifically, when the selecting unit 510 selects an advertisement category which is best proper for the current situation of the user, the determining unit 520 determines the advertisement which pertains to the selected specific advertisement category as the targeting advertisement for the user, such that the providing unit 530 can provide the determined targeting advertisement to the terminal device 300.

Meanwhile, when the selection permitted times for all of the advertisement category lists which are received from the situation analyzing device 400 have expired, or when the advertisement category selection operation is not performed at the selecting unit 510 since there exists no preselected advertisement category list, the determining unit 520 applies a separate targeting logic to determine an alternative targeting advertisement which is to be provided to the terminal device 300.

As described above, according to the advertisement platform device 500 according to the second embodiment of the present invention, a plurality of advertisement categories are preselected in the situation analyzing device 400 at the time instant before the advertisement request is received from the terminal device 300 by analyzing the real-time situation information which is collected for the user carrying the terminal device, and when the advertisement request is received from the terminal device 300, the advertisement platform device 500 selects a specific advertisement category which is proper for the time instant when the advertisement request is received from the selected advertisement categories to provide the targeting advertisement, thereby reducing a system load during the targeting advertisement selecting process and improving the accuracy of the targeting advertisement selecting process.

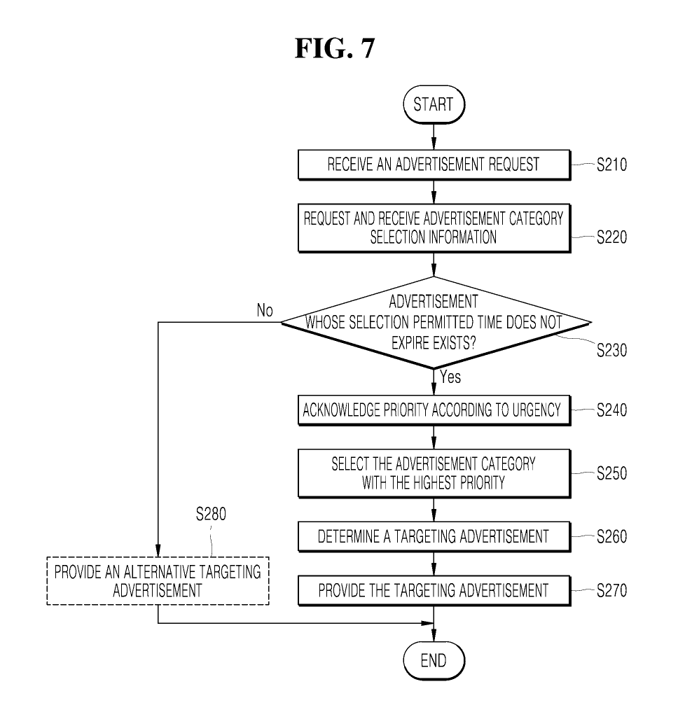

In the following, operations flows of the advertisement platform device 500 according to the second embodiment of the present invention are explained by referring to FIG. 7.

Here, the configurations described in the FIGS. 5 and 6 are referred to by using corresponding reference numbers for the convenience of description.

At first, when the advertisement request is received from the terminal device 300, the selecting unit 510 requests a plurality of advertisement category lists and receives them from the situation analyzing device 400 (S210-S220).

Then, the selecting unit 510 first selects the advertisement categories for which the selection permitted time has not elapsed at the time instant when the advertisement request is received from the terminal device 300 among the advertisement categories selected by the situation information analyzing device 400, and then selects a specific advertisement category with the highest priority as the advertisement category which is most proper for the current situation of the user among the selected advertisement categories (S230-S250).

Then, when the selecting unit 510 selects an advertisement category which is best proper for the current situation of the user, the determining unit 520 determines the advertisement which pertains to the selected specific advertisement category as the targeting advertisement for the user, such that the providing unit 530 can provide the determined targeting advertisement to the terminal device 300 (S260-S270).

Meanwhile, when the selection permitted times for all of the advertisement category lists which are received from the situation analyzing device 400 in step S230 have expired, or when the advertisement category selection operation is not performed at the selecting unit 510 since there exists no preselected advertisement category list at all, the determining unit 520 applies a separate targeting logic to determine an alternative targeting advertisement which is to be provided to the terminal device 300 (S280).

As described above, according to operation flow of the advertisement platform device 500 according to the second embodiment of the present invention, a plurality of advertisement categories are preselected in the situation analyzing device 400 at the time instant before the advertisement request is received from the terminal device 300 by analyzing the real-time situation information which is collected for the user carrying the terminal device, and when the advertisement request is received from the terminal device 300, the advertisement platform device 500 selects a specific advertisement category which is proper for the time instant when the advertisement request is received from the selected advertisement categories to provide the targeting advertisement, thereby reducing a system load during the targeting advertisement selecting process and improving the accuracy of the targeting advertisement selecting process.

Hereinafter, the third embodiment of the present invention will be described in detail by referring to appended drawings.

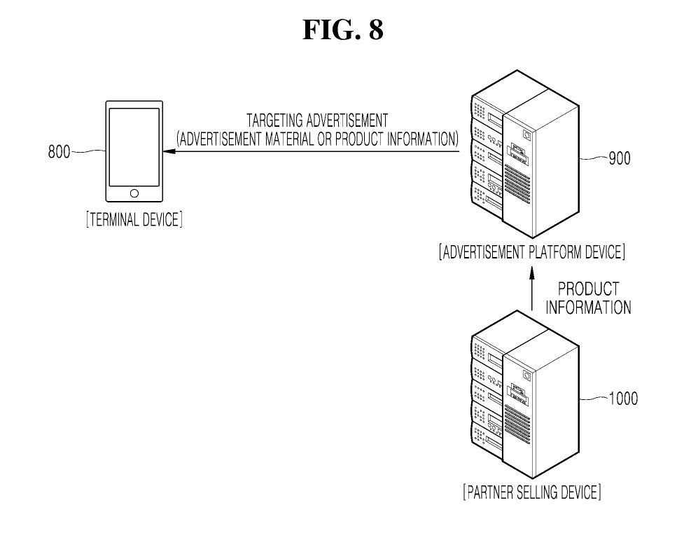

FIG. 8 is diagram showing an advertisement providing system according to a third embodiment of the present invention.

As shown in FIG. 8, the advertisement providing system according to the third embodiment of the present invention can have a configuration including a terminal device 800 which receives advertisements through an advertisement medium, an advertisement platform device 900 which selects and provides the targeting advertisement according to the advertisement request from the terminal device 800, and a partner selling device 1100 which provides the registered product information to the advertisement platform device 900.

The terminal device 800 refers to a mobile device which can receive the advertisement through an advertisement medium.

For example, a smart phone, a tablet PC, a PDA, and etc. can be included in the terminal device 800, and the terminal device 100 is not limited to these, and can include all devices which can receive the advertisement.

Here, the advertisement medium which enables the reception of the advertisement on the terminal device 800 can include, for example, an application which is executed on the terminal device 800 itself, or a service page (e.g.: web page) which the terminal device 800 can access through a called browser.

This advertisement medium includes a software development kit (SDK) which is related to the advertisement reception during a development process, and, the, the terminal device 800 performs a series operation of requesting, receiving, and displaying the advertisement through the SDK included in the advertisement medium.

The advertisement platform device 900 refers to a platform server which provides the advertisement which is registered from the advertiser to the terminal device 800.

When an advertisement provision is requested from the terminal device 800, this advertisement platform device 900 selects the targeting advertisement which is proper for user carrying the terminal device 800 among the advertisements which are registered from the advertiser, and comes to provide the selected targeting advertisement to the terminal device 800.

The partner selling device 1100 refers to a seller server (e.g.: shopping mall server) which has a business association with the advertisement platform device 900, and the partner selling device 1100 sell products by registering the product information on various products on line and providing the product information to a purchaser who accesses the server on line.

Meanwhile, according to the third embodiment of the present invention, when an advertisement request is received from the terminal device 800, the advertisement platform device 900 selects the advertisement which is proper for the current situation of the user who carries the terminal device 800 using a targeting logic of itself and provides the selected advertisement to the terminal device 800 as the targeting advertisement.

Generally, according to the provision method of the targeting advertisement performed in the advertisement platform device 900, the advertiser directly sets the targeting conditions of the advertisement while registering the advertisement, such that the advertisement in the advertisement platform device 900. which is proper for the set targeting conditions, can be provided to the user as the targeting advertisement.

Meanwhile, in order to improve the performance of the advertisement platform device 900 which provides the targeting advertisement as above, it is accepted as necessary conditions that a large number of targeting subjects should be obtained, and a high quality targeting logic for selecting the targeting advertisement has to be established.

However, what is required to improve the performance of the advertisement platform device 900 is to obtain a sufficient number of advertisements which are to be provided to the target in addition to the conditions mentioned above, and when the sufficient amount of advertisements is not obtained, the targeting advertisement cannot be provided at right times and right amounts, which reduces an advertisement (conversion rate) and further results in performance degradation of the advertisement platform device.

Therefore, according to the third embodiment of the present invention, a measure which readily provides the targeting advertisement, even when the advertisement amount is not enough at the time instant when the advertisement is requested, is provided by actively reflecting the current situation of the user related to the time instant when the advertisement is requested in order to improve the conversion rate, and the advertisement platform device 900 for implementing this measure will be explained in detail in the following.

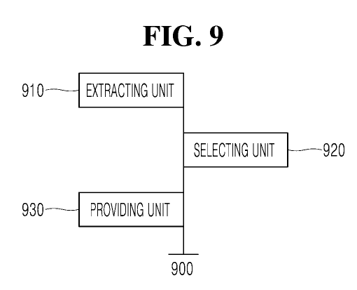

FIG. 9 is a diagram showing a schematic configuration of an advertisement platform device 900 according to the third embodiment of the present invention.

As shown in FIG. 9, the advertisement platform device 900 according to the third embodiment of the present invention has a configuration including an extracting unit 910 which extracts the advertisement selection information, and a selecting unit 920 which selects the targeting advertisement.

Also, the advertisement platform device 900 according to the third embodiment of the present invention can have a configuration which further includes a providing unit 530 that provides the targeting advertisement to the terminal device 800, in addition to the aforementioned configuration.

Here, all or a part of the configuration of the advertisement platform device 900 comprising the aforementioned extracting unit 910, the selecting unit 920, and the providing unit 930 can be implemented as a software module executed by a processor or as a combination of the software module and a hardware.

At first the extracting unit 910 performs a function of extracting the advertisement selection information for selecting the targeting advertisement.

More specifically, when an advertisement request is received from the terminal device 800, the extracting unit 910 comes to extract the advertisement selection information which is required for selecting the targeting advertisement that is proper for the user who carries the terminal device 800.

In the meantime, the extracting unit 910 extracts, for example, weather information at the position of the terminal device 800, emotional information of the user who carries the terminal device 800, and the user characteristic information of the user who carries the terminal device 800 at the time instant when the advertisement request is received, as the advertisement selection information.

Here, the weather information can be included in the advertisement request which is received from terminal device 800.

Thus, when the advertisement request is received from the terminal device 800, the extracting unit 910 extracts the weather information included in the corresponding advertisement request as one of the advertisement selection information.

In connection with this, when the terminal device 800 tries to request an advertisement from the advertisement platform device 900, it obtains the real time weather information at the current position from a specific application on which an application programming interface (API) for providing the real time weather information is installed, includes the obtained weather information to the advertisement request, and provides the advertisement request to the advertisement platform device 900.

For reference, the weather information which is delivered from the terminal device 800 can be classified as in table 1.

TABLE I

| Major classification | Minor classification |
|---|---|
| General | Temperature is not higher than 24.5 in one of clear/ |
| | partially cloudy/heavy cloudy/cloudy and lighting |
| Rain (Rain) | Heavy cloudy and rainy/snowy |
| | Cloudy and rain /snowy |
| | Lighting rain, rainy/snowy |
| High temperature | Temperature is not higher than 24.5 in one of clear/ |
| (H_temp) | partially cloudy/heavy cloudy/cloudy and lighting |
| Yellow sand | Yellow send warning, special weather report |
| (Y_sand) | |
| Dry (Dry) | Drought warning, special weather report |

Also, as for the emotional information, it can be extracted based on user identification information (e.g.: MDN) which is included in the advertisement request received from the terminal device 800.

Therefore, when the advertisement request is received from the terminal device 800, the extracting unit 910 identifies the user identification information included in the corresponding advertisement request, and acknowledges a specific social network service to which the user who carries the terminal device 800 subscribes based on the identified user identification information.

Here, user posts which can reflect current emotion of the user carrying the terminal device 800 can be updated in real time in the specific social network service to which it is acknowledged that the user has subscribed.

As a result, when the specific social network service to which the user carrying the terminal device 800 subscribes is acknowledged, the extracting unit 910 performs an analysis on keywords for the user posts on the acknowledged specific social network service to extract the emotional information (e.g.: pleased, sad, gloomy, boring, angry, etc.) for the user at the time instant when the advertisement request is delivered.

Also, as for the user characteristic information, it can be extracted based on user identification information which is included in the advertisement request received from the terminal device 800 similarly to the aforementioned emotional information.

Therefore, when the advertisement request is received from the terminal device 800, the extracting unit 910 identifies the user identification information included in the corresponding advertisement request, and comes to extract the user characteristic information (e.g.: a place of living, sex, an age, preference, and a hobby, etc.) corresponding to the user characteristic information which is identified by using a personal tendency analysis device, for example an ISF.

The selecting unit 920 performs a function of selecting the targeting advertisement.

More specifically, when the extraction of the advertisement selection information which is related to the time instant when the advertisement request is received is completed, the selecting unit 920 comes to select the targeting advertisement to be provided to the terminal device 800 based on the extracted advertisement selection information.

In the meantime, in selecting the targeting advertisement to be provided to the terminal device 800, the selecting unit 920, when an advertisement whose targeting conditions meet all of the extracted advertisement selection information, that is, the weather information, the emotional information, and the user characteristic information among the advertisements registered from the advertiser, exists, sets this advertisement as the targeting advertisement, and enables the providing unit 230 to provide the selected targeting advertisement to the terminal device 800.

On the contrary, when the targeting conditions which are set for the advertisement registered from the advertiser fail to meet the extracted advertisement selection information, the selecting unit 920 selects the product information, which meets the extracted advertisement selection information, among the product information registered in the partner selling device 1100 as the targeting advertisement to be provided to the terminal device 800.

For example, in the case that ‘yellow dust’, ‘gloomy’, ‘female in twenties’, and ‘Gangnam’ are extracted as the weather information, the emotional information, the user characteristic information, and the place of living, respectively, when the set targeting conditions meet the weather information and the emotional information but fail to meet the user characteristic information, the product information (e.g.: female masks) which corresponds to at least one of the weather information, the emotional information, and the user characteristic information among the product information registered in the partner selling device 1100 can be selected as the targeting advertisement.

As described above, according to the advertisement platform device 900 according to the third embodiment of the present invention, since the advertisement registered from the advertiser is selected as the targeting advertisement based on the advertisement selection information including the weather information, the emotional information, and the user characteristic information, it is possible to actively reflect the current situation of the user related to the time instant when the advertisement is requested.

Also, according to the advertisement platform device 900 according to the third embodiment of the present invention, when there exists no advertisement which is proper for the advertisement selection information while selecting the targeting advertisement, the product information which is registered on the partner selling device is provided as the targeting advertisement, and, therefore, the targeting advertisement can be readily provided even when there is an insufficient amount of advertisement at the time instant when the advertisement is requested, and the advertisement conversion rate can be greatly improved.

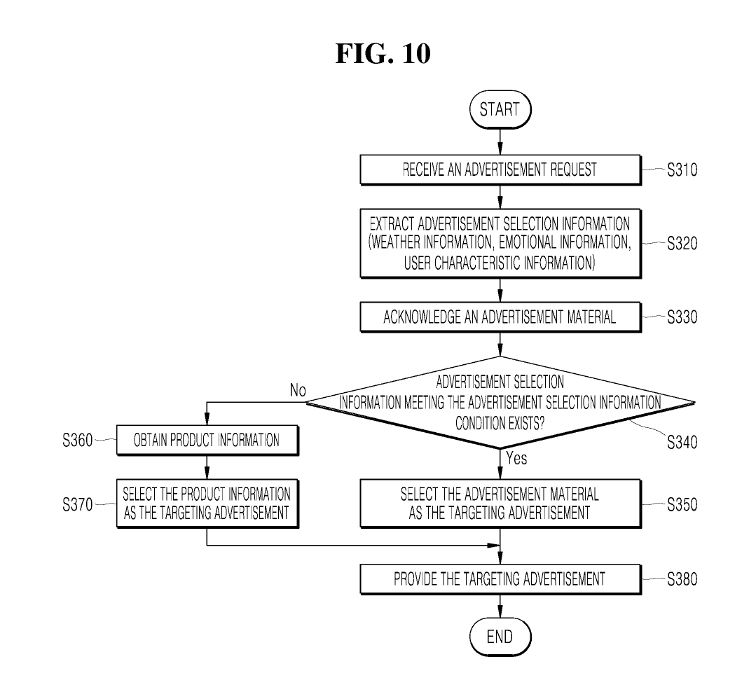

In the following, operations flows of the advertisement platform device 900 according to the third embodiment of the present invention will be explained by referring to FIG. 10.

Here, the configurations described in the FIGS. 8 and 9 are referred to by using corresponding reference numbers for the convenience of description.

At first, when an advertisement request is received from the terminal device 800, the extracting unit 910 comes to extract the advertisement selection information which is required for selecting the targeting advertisement that is proper for the user who carries the terminal device 800 (S310-S320).

In the meantime, the extracting unit 910 extracts, for example, the weather information at the position of the terminal device 800, the emotional information of the user who carries the terminal device 800, and the user characteristic information of the user who carries the terminal device 800 at the time instant when the advertisement request is received, as the advertisement selection information.

Here, the weather information is included in the advertisement request which is received from the terminal device 800, and, when the advertisement request is received from the terminal device 800, the extracting unit 900 extracts the weather information included in the corresponding advertisement request as one of the advertisement selection information.

Also, as for the emotional information, it can be extracted based on the user identification information (e.g.: MDN) which is included in the advertisement request received from the terminal device 800, and, thus when the advertisement request is received from the terminal device 800, the advertisement platform device 900 identifies the user identification information included in the corresponding advertisement request, and acknowledges a specific social network service to which the user who carries the terminal device 800 subscribes based on the identified user identification information.

Like this, when the specific social network service to which the user carrying the terminal device 800 subscribes is acknowledged, the extracting unit 910 performs an analysis on keywords for the user posts on the acknowledged specific social network service to extract the emotional information (e.g.: pleased, sad, gloomy, boring, angry, etc.) for the user at the time instant when the advertisement request is delivered.

Also, the user characteristic information can also be extracted based on the user identification information included in the advertisement request which is received from the terminal device 800, and, therefore, when the advertisement request is received from the terminal device 800, the extracting unit 910 identifies the user identification information included in the corresponding advertisement request, and comes to extract the user characteristic information (e.g.: a place of living, sex, an age, preference, and a hobby, etc.) corresponding to the user characteristic information which is identified by using a personal tendency analysis device, for example an ISF.

Then, when the extraction of the advertisement selection information which is related to the time instant when the advertisement request is received is completed, the selecting unit 920 selects the targeting advertisement to be provided to the terminal device 800 based on the extracted advertisement selection information (S330-S350).

In the meantime, in selecting the targeting advertisement to be provided to the terminal device 800, the selecting unit 920, when an advertisement whose targeting conditions meet all of the extracted advertisement selection information, that is, the weather information, the emotional information, and the user characteristic information among the advertisements registered from the advertiser, exists, comes to set this advertisement as the targeting advertisement.

Meanwhile, when the targeting conditions which are set for the advertisement registered from the advertiser fail to meet the extracted advertisement selection information, the selecting unit 920 comes to select the product information, which meets the advertisement selection information from the partner selling device 1100, and selects the product information as the targeting advertisement to be provided to the terminal device 800.

Then, when the selection for the targeting advertisements are completed by using the aforementioned process, the providing unit 930 provides the selected targeting advertisement to the terminal device 800 (S290).

As described above, according to operation flows of the advertisement platform device 300 according to the third embodiment of the present invention, since the advertisement registered from the advertiser is selected as the targeting advertisement based on the advertisement selection information including the weather information, the emotional information, and the user characteristic information, it is possible to actively reflect the current situation of the user related to the time instant when the advertisement is requested.

Also, according to the advertisement providing method 900 according to the third embodiment of the present invention, when there exists no advertisement which is proper for the advertisement selection information while selecting the targeting advertisement, the product information which is registered on the partner selling device is provided as the targeting advertisement, and, therefore, the targeting advertisement can be readily provided even when there is an insufficient amount of advertisement at the time instant when the advertisement is requested, and the advertisement conversion rate can be greatly improved.

Hereinafter, the fourth embodiment of the present invention will be described in detail by referring to appended drawings.

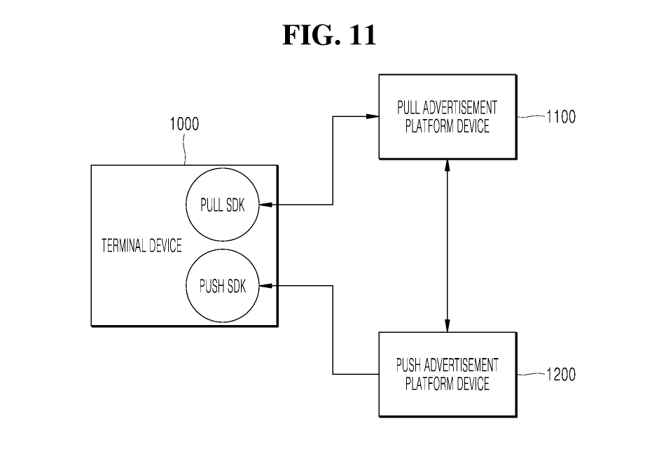

FIG. 11 is diagram showing an advertisement providing system according to a fourth embodiment of the present invention.

As shown in FIG. 11, the advertisement providing system according to the fourth embodiment of the present invention has a configuration including a terminal device 1000 which receives advertisements using an advertisement medium, an advertisement platform device (1100; ‘pull advertisement platform device’, hereinafter) which provides the advertisement according to a pull technique, and an advertisement platform device (1200, ‘push advertisement platform device’, hereinafter) which provides the advertisement according to a push technique.

The terminal device 1000 refers to a mobile device which can receive the advertisement through an advertisement medium.

For example, a smart phone, a tablet PC, a PDA, and etc. can be included in the terminal device 1000, and the terminal device 100 is not limited to these, and can include all devices which can receive the advertisement.

Here, the advertisement medium which enables the reception of the advertisement on the terminal device 1000 can include, for example, an application which is executed on the terminal device 1000 itself, or a service page (e.g.: web page) which the terminal device 1000 can access through a called browser.

This advertisement medium includes a software development kit (SDK) which is related to the advertisement reception during a development process, and, the, the terminal device 1000 performs a series operation of requesting, receiving, and displaying the advertisement through the SDK included in the advertisement medium.

The pull advertisement platform device 1100 refers to an advertisement platform server which provides the advertisement to the terminal device 1000 according to the pull technique.

When an advertisement provision is requested from the terminal device 1000, this pull advertisement platform device 1100 selects the targeting advertisement which is proper for the terminal device 1000 among the advertisements which are registered from the advertiser, and comes to provide the targeting advertisement to the terminal device 1000.

The push advertisement platform device 1200 refers to an advertisement platform server which provides the advertisement to the terminal device 1000 according to the push technique.

This push advertisement platform device 1200 selects a plurality of terminal devices which are proper for receiving the specific targeting advertisement registered from the advertiser as a push advertisement target, and when the terminal device 1000 is selected as the push advertisement target, the push advertisement platform device 1200 unilaterally comes to provide the specific targeting advertisement to the terminal device 1000 irrespective of the advertisement request from the terminal device 1000.

Meanwhile, according to an embodiment of the present invention, the terminal device 1000 can receive the targeting advertisements according to both the push technique and the pull technique at the same time, and, in order to accomplish this, respective targeting logics are applied to the pull advertisement platform device 1100 and the push advertisement platform device 1200, such that the targeting advertisement is provided to the terminal device 1000.

As mentioned above, as for the targeting logic in the push advertisement platform device 1200, a leading method which preselects a plurality of terminal devices proper for receiving the specific targeting advertisement registered from the advertiser as the push advertisement targets, is used to provide the targeting advertisement.

On the contrary, as for the targeting logic in the pull advertisement platform device 1100, when the advertisement provision is requested from the terminal device 1000, a lagging method which selects the targeting advertisement proper for the terminal device 1000 by utilizing personal information and a behavior database of the user who carries the terminal device 1000 is used to provide the selected targeting advertisement to the terminal device 1000.

As a result, according to conventional advertisement systems, in order to receive the targeting advertisements according to both the push and pull techniques at the same time, separate targeting logics are to be realized in each of the pull advertisement platform device 1100 and the push advertisement platform device 1200, which greatly reduces the efficiency of an advertisement providing system.

Therefore, according to an embodiment of the present invention, a measure which integrates the targeting logics according to the push and pull techniques is proposed, and the configuration of the advertisement platform device 1100 for implementing this measure will be explained in detail in the following.

Prior to further description, the identification information of the terminal devices 1000 are to be shared with each other in order to integrate the targeting logics between the pull advertisement platform device 1100 and the push advertisement platform device 1200.

In order to accomplish this, the operations as follow can be performed in the terminal device 1000 where the advertisement medium according to the push technique (′push advertisement medium′, hereinafter) and the advertisement medium according to the pull technique (‘pull advertisement medium’, hereinafter) are respectively installed.

That is, when the push advertisement medium is initially installed on the terminal device 1000, the push advertisement medium registers the terminal device 1000 on the push advertisement platform device 1200 for receiving the targeting advertisement, and the push advertisement platform device 1200 returns identification information (ID) of the 1000 which is issued during a registration process to the push advertisement medium.

And, the push advertisement medium delivers the identification information of the terminal device 1000 which is received from the push advertisement platform device 1200 to the pull advertisement medium, and, then the pull advertisement medium which received it transmits the identification information of the corresponding terminal device 1000 to the pull advertisement platform device 1100 to be registered.

As a result, the pull advertisement platform device 1100 comes to share the identification information of the terminal device 1000 which is registered in the push advertisement platform device 1200, and the pull advertisement platform device 1100 can use the identification information system of the terminal device 1000 which is issued from the push advertisement platform device 1200 in the same way.

In case that the identification information system of the terminal device 1000 which is issued by the push advertisement platform device 1200 is different from that of its own, it can recognize the identification information system of the terminal device 1000 issued from the push advertisement platform device 1200 by using a separate mapping table.

Meanwhile, when the targeting advertisement is registered by the advertiser, the push advertisement platform device 1200, as in the conventional method, selects the terminal devices, which are proper for receiving the registered targeting advertisement using the targeting logic of the leading method, as the push advertisement target, and maintains the push advertisement target.

In the following, the identification information is shared between the pull advertisement platform device 1100 and the push advertisement platform device 1200 according to the aforementioned process, and the description will be based on the assumption that the push advertisement target has already been selected in the push advertisement platform device 1200.

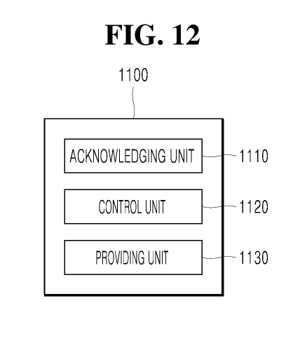

FIG. 12 is a diagram showing a schematic configuration of a pull advertisement platform device 1100 according to the fourth embodiment of the present invention.

As shown in FIG. 12, the pull advertisement platform device 1100 according to the fourth embodiment of the present invention has a configuration including: an acknowledging unit 1110 which determines whether the terminal device 1000 has been selected as the push advertisement target, and a control unit 1120 which controls the targeting advertisement to be provided to the terminal device 1000.

Also, the pull advertisement platform device 1100 according to the fourth embodiment of the present invention can have a configuration which further includes a providing unit 1130 that provides the targeting advertisement to the terminal device 1000, in addition to the aforementioned configuration.

Here, all or a part of the configuration of the pull advertisement platform device 1100 comprising the aforementioned acknowledging unit 1110, the control unit 1120, and the providing unit 1130 can be implemented as a software module executed by a processor or as a combination of the software module and a hardware.

The acknowledging unit 1110 performs a function of acknowledging whether the terminal device 1000 is selected as the push advertisement target.

More specifically, when the provision of the advertisement is requested to the terminal device 1000, the acknowledging unit 1110 acknowledges whether the terminal device 1000, which has requested the advertisement provision to the push advertisement target which has been selected to receive the specific targeting advertisement according to the push technique, has been selected.

In the meantime, the acknowledging unit 1110 is interlinked with the push advertisement platform device 1200 to acknowledge the identification information of each of the terminal devices, which have been selected as the push advertisement target for receiving the specific targeting advertisement, and when the identification information of the terminal device 1000 exists among the acknowledged identification information, it can acknowledge that the terminal device 1000 has been selected as the push advertisement target for receiving the specific targeting advertisement.

Like this, the acknowledging unit 1110 acknowledges the identification information of each of the terminal devices, which have been selected as the push advertisement target at the push advertisement platform device 1200, and acknowledges whether the terminal device 1000 has been selected as the push advertisement target, and it is made possible because the identification information of the terminal device 1000 and the system thereof are priorly shared between the pull advertisement platform device 1100 and the push advertisement platform device 1200 as mentioned above.

The control unit 1120 performs a control function such that the targeting advertisement is provided to the terminal device 1000.

More specifically, when the terminal device which has requested the provision of the advertisement has been acknowledged as the push advertisement target for receiving the specific targeting advertisement at the push advertisement platform device 1200, the control unit 1120 controls the providing unit 1130 to provide the specific targeting advertisement, for which the targeting has been completed at the push advertisement platform device 1200, to the terminal device 1000 as the targeting advertisement.

As a result, only by sharing the identification information of the terminal device 1000 and the system thereof with the push advertisement platform device 1200, the control unit 1120 can provide the targeting advertisement to the terminal device 1000 even when no targeting of its own is implemented.

Meanwhile, when the terminal device which has requested the provision of the advertisement is not selected as the push advertisement target in the push advertisement platform device 1200, the control unit 1120 can control such that a lagging type targeting logic, which, as conventional methods, selects the targeting advertisement proper for the terminal device 1000 based on the personal information of the user carrying the terminal device 1000 and the behavior databases and provides the selected targeting advertisement to the terminal device 1000, is additionally applied.

As described above, according to the pull advertisement platform device 1100 according to the fourth embodiment of the present invention, it is possible to provide the targeting advertisement to the terminal device 1000 without establishing a targeting logic of itself only by sharing identification information and its system of the terminal device 1000 with a push advertisement platform device 1200, and, therefore, the efficiency of the advertisement providing system can be greatly improved.

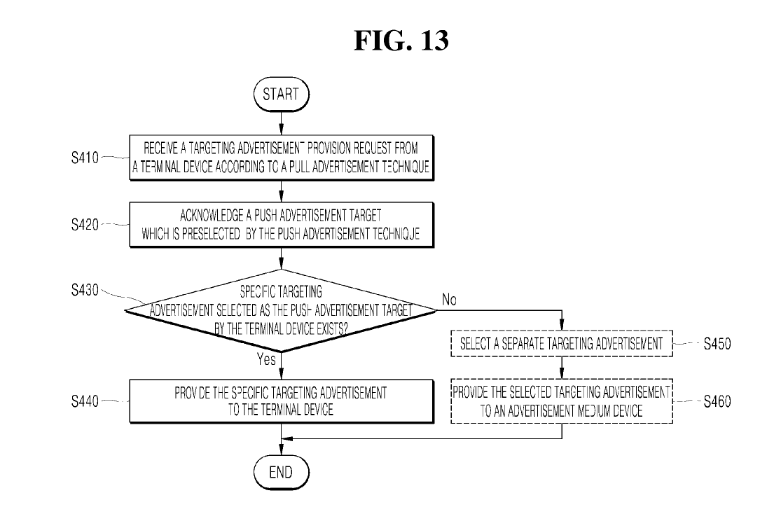

In the following, operations flows of the pull advertisement platform device 1200 according to the fourth embodiment of the present invention are explained by referring to FIG. 13.

Here, the configurations described in the FIGS. 11 and 12 are referred to by using corresponding reference numbers for the convenience of description.

At first, when the provision of the advertisement is requested to the terminal device 1000, the acknowledging unit 1110 acknowledges whether the terminal device 1000, which has requested the advertisement provision to the push advertisement target which has been selected to receive the specific targeting advertisement according to the push technique, has been selected (S410-S420).

In the meantime, the acknowledging unit 1110 is interlinked with the push advertisement platform device 1200 to acknowledge the identification information of each of the terminal devices, which have been selected as the push advertisement target for receiving the specific targeting advertisement, and when the identification information of the terminal device 1000 exists among the acknowledged identification information, it can acknowledge that the terminal device 1000 has been selected as the push advertisement target for receiving the specific targeting advertisement.

Like this, the acknowledging unit 1110 acknowledges the identification information of each of the terminal devices, which have been selected as the push advertisement target at the push advertisement platform device 1200, and acknowledges whether the terminal device 1000 has been selected as the push advertisement target, and it is made possible because the identification information of the terminal device 1000 and the system thereof are priorly shared between the pull advertisement platform device 1100 and the push advertisement platform device 1200 as mentioned above.

Then, when the terminal device which has requested the provision of the advertisement has been acknowledged as the push advertisement target for receiving the specific targeting advertisement at the push advertisement platform device 1200, the control unit 1120 controls the providing unit 1130 to provide the specific targeting advertisement, for which the targeting has been completed at the push advertisement platform device 1200, to the terminal device 1000 as the targeting advertisement (S430-S440).

Meanwhile, when it is acknowledged that the terminal device 1000 which has requested the provision of the advertisement is not selected as the push advertisement target in the push advertisement platform device 1200, the control unit 1120 controls such that a lagging type targeting logic, which, as conventional methods, selects the targeting advertisement proper for the terminal device 1000 based on the personal information of the user carrying the terminal device 1000 and the behavior databases and provides the selected targeting advertisement to the terminal device 1000, is additionally applied (S450-S460).

As described above, according to the operation flows of the pull advertisement platform device 1100 according to the fourth embodiment of the present invention, it is possible to provide the targeting advertisement to the terminal device 1000 without establishing a targeting logic of itself only by sharing identification information and its system of the terminal device 1000 with a push advertisement platform device 1200, and, therefore, the efficiency of the advertisement providing system can be greatly improved.

Meanwhile, the realized articles of functional operations and subject matters described in this specification can be implemented using digital electronic circuits, or implemented as computer software, firmware, or hardware including the configuration disclosed in this specification and structural equivalents thereof, or as a combination be at least one of these implementations. The articles of realization of the subject matter described in this specification can be implemented as one or more computer program product, that is, one or more module related to computer program instructions which are encoded on a tangible program storage medium for controlling the operation of the process system or for being executed by the same.

The computer-readable medium can be a machine-readable storage device, a machine-readable storage board, a memory device, a composition of materials affecting machine-readable wave signals, and a combination of at least one of them.

The term such as “a system” or “a device” in this specification encompasses all tools, devices, and machines for processing data including, for example, a programmable processor, a computer, or a multi-processor. The process system can include a code for creating an execution atmosphere for the computer program, when requested by a code constituting a processor firmware, a protocol stack, a database management system, an operating system, or a combination of at least one of them, etc., in addition to a hardware.

The computer (also known as a program, a software, a software application, a script, or a code) can be created in all types of program languages including a compiled or interpreted language or a priori or procedural language, and can be arranged in all types including standalone programs, modules, subroutines, and other units proper to be used in a computing environment. The computer program does not necessarily correspond to a file of a file system. The program can be stored in a single file provided by the requested program, in multiple files which interact with each other (for example, files storing one or more module, low level programs or some of the code), or in a part of the file containing other programs or data (for example, one or more script stored in a markup language document). The computer program can be arranged to be positioned in one site or distributed over a plurality of sites, such that it can be executed on multiple computers interconnected via a communication network or on a single computer.

Meanwhile, the computer-readable medium which is proper for storing computer program instructions and data can include and all types of nonvolatile memories, media, and memory devices including a semiconductor memory device such as EPROM, EEPROM and flash memory device, a magnetic disk such as internal hard disk or removable disk, optical disk, a CD-ROM and a DVD-ROM disk. The processor and the memory can be supplemented by a special purpose logic circuit or integrated into the same.

The article of realization of the subject matter described in this specification can include a back-end component such as a data server, a middleware component such as an application server, or a front-end component such as a client computer having a web browser or a graphic user interface which enables a user to interact with the article of realization of the subject matter described in this specification, or can implement all combinations of these back-end, middleware, or front-end components in a computing system. The components of a system can be interconnected with each other by all types or media of digital data communication such as a communication network.

Although this specification includes details of various specific implementations, it is not to be understood as limiting for all inventions or scope to be claimed, and it should rather be understood as an explanation for the features which can be unique to specific implementations of the specific invention. Similarly, the specific features described in this specification in the context of separate implementations can be implemented to be combined in a single implementation. On the contrary, various features described in the context of the single implementation can also be implemented as discrete or proper low level combinations as well as in various implementations. Furthermore, although the features can be depicted as work in a specific combination and as claimed in the first place, one or more features from the claimed combination can be excluded from the combination in some cases, and the claimed combination can be changed to the low level combinations or subcombinations.

Also, although this specification depicts the operations in a specific order in the drawings, it is not to be understood that this specific sequence or order should be maintained or all the shown operations should be performed in order to obtain the preferred results In specific cases, multitasking and parallel processing can be preferable. Also, the division of various system components of the aforementioned embodiments are not to be construed as being required by all embodiments, and it is to be understood that the described program components and systems can generally be unified into a single software product or packaged in multiple software products.

Similarly, this specification is not intended to limit the present invention to specific terms provided. Therefore, although the present invention has been explained in detail by referring to the aforementioned examples, it is possible for the person having ordinary skill in the art to alter, change, or modify these examples without departing from the scope of the present invention. The scope of the present invention is expressed by the claims, not by the specification, and all changes and modified shapes derived from the meanings of the claims, scopes, and the equivalents thereof are construed to be included in the scope of the present invention.

What is claimed is:

1. An advertisement platform device characterized in comprising:
a determining unit which, when an advertisement request is received from a terminal device, determines whether an advertisement provision toward the terminal device is possible based on the advertisement subscription information for restricting a reception of the advertisement at the terminal device; and
a control unit which, when it is determined that the advertisement provision toward the terminal device is possible, enables an advertisement which is selected for the terminal device to be provided to the terminal device.

2. The advertisement platform device of claim 1, characterized in that the advertisement subscription information includes at least one of: an advertisement reception permission number, which is the number that the advertisement reception is permitted for every preset advertisement reception period, and the advertisement categories selected from the terminal device.

3. The advertisement platform device of claim 2, characterized in that the determining unit determines that the advertisement provision toward the terminal device is possible, when there is the advertisement reception permission number left for a specific advertisement reception period during which a time instant when the advertisement request is received is included, or when there exists a specific advertisement category for which the terminal device fails to receive the advertisement among the advertisement categories selected from the terminal device.

4. The advertisement platform device of claim 1, characterized in that the advertisement which is selected for the terminal device is selected based on at least one of: real-time situation information of the user who carries the terminal device, weather information at the time instant when the advertisement request is received, and emotional information of the user who carries the terminal device.

5. The advertisement platform device of claim 4, characterized in that the advertisement which is selected for the terminal device is the advertisement of the specific advertisement category whose advertisement effect is maintained only for the shortest time period from the time instant when the advertisement request is received among the plurality of advertisement categories for which it is predicted that the advertisement effect exists for the terminal device based on the real-time situation information.

6. The advertisement platform device of claim 4, characterized in that the weather information is the information which is included in the advertisement request which is provided from a specific application in the terminal device and received from the terminal device.

7. The advertisement platform device of claim 4, characterized in that the emotional information is the information which is extracted from a user post in a specific social network service, which is acknowledged based on the user identification information included in the advertisement request received from the terminal device.

8. The advertisement platform device of claim 1, characterized in that the control unit, when there is no advertisement which is selected for the terminal device, enables specific product information, which is selected for the terminal device among a plurality of pieces of product information registered on a partner selling device, to be provided to the terminal device.

9. An advertisement platform device characterized in comprising:
a providing unit which provides advertisements to a terminal device according to a first advertisement provision method;
an acknowledging unit which, when identification information is received from the terminal device, acknowledges whether the identification information has been generated for the terminal device at another advertisement platform device which conforms to a second advertisement provision method; and
a control unit which, when the identification information is acknowledged to have been generated for the terminal device, enables a specific advertisement, which is selected to be provided from the another advertisement platform device to the terminal device, to be provided according to the first advertisement provision method.

10. An operation method of an advertisement platform device characterized in comprising:
a determining step which, when an advertisement request is received from a terminal device, determines whether an advertisement provision toward the terminal device is possible based on the advertisement subscription information for restricting a reception of the advertisement at the terminal device; and
a control step which, when it is determined that the advertisement provision toward the terminal device is possible, enables an advertisement which is selected for the terminal device to be provided to the terminal device.

11. The operation method of an advertisement platform device of claim 10, characterized in that the advertisement subscription information includes at least one of: an advertisement reception permission number, which is the number that the advertisement reception is permitted for every preset advertisement reception period, and the advertisement category selected from the terminal device.

12. The operation method of an advertisement platform device of claim 11, characterized in that the determining step determines that the advertisement provision toward the terminal device is possible, when there is the advertisement reception permission number left for a specific advertisement reception period during which a time instant when the advertisement request is received is included, or when there exists a specific advertisement category for which the terminal device fails to receive the advertisement among the advertisement categories selected from the terminal device.

13. The operation method of an advertisement platform device of claim 10, characterized in that the advertisement which is selected for the terminal device is selected based on at least one of: real-time situation information of the user who carries the terminal device, weather information at the time instant when the advertisement request is received, and emotional information of the user who carries the terminal device.

14. The operation method of an advertisement platform device of claim 13, characterized in that the advertisement which is selected for the terminal device is the advertisement of the specific advertisement category whose advertisement effect is maintained for the shortest time period from the time instant when the advertisement request is received among the plurality of advertisement categories for which it is predicted that the advertisement effect exists for the terminal device based on the real-time situation information.

15. The operation method of an advertisement platform device of claim 13, characterized in that the weather information is the information which is included in the advertisement request which is provided from a specific application in the terminal device and received from the terminal device.

16. The operation method of an advertisement platform device of claim 13, characterized in that the emotional information is the information which is extracted from a user post in a specific social network service, which is acknowledged based on the user identification information included in the advertisement request received from the terminal device.

17. The operation method of an advertisement platform device of claim 10, characterized in that the control step, when there is no advertisement which is selected for the terminal device, enables specific product information, which is selected from the terminal device among a plurality of pieces of product information registered on a partner selling device, to be provided to the terminal device.
